(19) United States
(12) Patent Application Publication
(10) Pub. No.: US 2026/0337798 A1
(43) Pub. Date: Oct. 29, 2026

(54) FREE-STANDING ELECTRODES WITH SINGLE-ATOM CATALYSTS ON NANOCARBON FIBERS

(71) Applicant: BAR-ILAN UNIVERSITY, Ramat Gan (IL)

(72) Inventors: Gilbert Daniel Nessim, Ramat Beit Shemesh (IL); Efrat Shawat Avraham, Petach Tikva (IL); Bibhudatta Malik, Ramat Gan (IL)

(21) Appl. No.: 19/485,847

(22) PCT Filed: Jun. 5, 2024
(86) PCT No.: PCT/IL2024/050557

§ 371 Date: Nov. 19, 2025

Related U.S. Application Data
(60) Provisional application No. 63/506,736, filed on Jun. 7, 2023.

(51) Int. Cl. C25B 11/091; C25B 1/04; C25B 3/23; C25B 3/26; C25B 11/053; C25B 11/056; C25B 11/065

(52) U.S. Cl. CPC C25B 11/091; C25B 1/04; C25B 11/053; C25B 11/056; C25B 11/065; C25B 3/23; C25B 3/26

(57) ABSTRACT

The invention provides bi-functional catalysts and electrodes based on Earth abundant metals, catalyzing cathodic hydrogen evolution and anodic oxygen evolution. The catalysts and electrodes are efficient for various electrochemical applications, including water splitting.

### FIELD OF THE INVENTION

The present invention relates to the fields of catalysts and free-standing electrodes, and more specifically to free-standing electrodes with single atom catalysts. Particularly, the invention relates to employing said electrodes in energy applications. More particularly, the invention relates to hydrogen evolution reaction and oxygen evolution reaction.

### BACKGROUND OF THE INVENTION

Exploration of green energy sources is necessitated by the expanding global energy demand, by the limited reserves of fossil fuels in nature, and by environmental concerns. Electrochemical water splitting producing hydrogen can contribute to resolving the global energy crisis. Hydrogen-based energy conversion devices are promising candidates for high-performance fuel cell powered vehicles. Electrocatalytic water splitting involves a cathodic hydrogen evolution reaction (HER) and an anodic oxygen evolution reaction (OER). According to thermodynamic calculations, H₂ and O₂ can be obtained at an efficiency of up to 80%.

In practice, H₂ evolution is hindered by the sluggish kinetics of the OER. Therefore, the OER is considered as the bottleneck of water splitting, involving a complex process of adsorption and desorption of intermediates which requires a larger overpotential to drive the anodic reaction (E⁰=1.23 V vs. reversible hydrogen electrode). Fortunately, the use of efficient and high-performance electrocatalysts can reduce the overpotential of anodic OER. Currently, systems based on platinum group metals (PGM), comprising, for example, IrO₂, RuO₂ or Pt, are used as state-of-the-art electrocatalysts for OER and HER. Said systems are, however, not appropriate for large-scale applications, among others due to low abundance and high cost of the employed metals. In this regard, a new class of efficient OER electrocatalysts has emerged-single atom catalysts (SACs); SACs comprise metals dispersed finely in a nonmetal matrix, possibly to the atomic level, advantageously comprising also cheaper metals.

A variety of metal SACs have been examined for their performance in the HER and/or OER. Ni/Co/Fe based SACs constructed over heteroatom-doped carbon systems exhibit efficient OER electrocatalysis in alkaline medium. However, obtaining SACs in a sufficiently dense array is quite challenging, as single atoms tend to aggregate into metal clusters to lower the surface energy during synthesis. Various strategies such as pyrolysis, chemical vapor deposition (CVD), atomic layer deposition, wet chemistry, atom trapping, and photochemical methods were tried, but numerous problems were encountered: for example, pyrolysis produces carbon-based residues due to the breakdown of metal-organic complexes; wet chemistry provides rather trial-and-error methods due to poorly understood synthesis mechanisms; and atom trapping is a complicated high temperature process that requires mobile metal species and a support material that can trap it. Only low metal loadings have been achieved, which has limited the use of SACs in industry. It is therefore an object of the invention to provide a simple and industrially scalable process for making single atom catalysts (SACs) efficient in oxygen evolution reaction (OER).

In addition to the electrocatalytic activity, the long-term stability and robustness of an electrocatalyst are also crucial parameters for practical applications. Electrodes based on catalytic powders employ binders (e.g. conducting polymers such as Nafion) to immobilize the catalytic material to the current collector substrate, and the binders often lose strength and the catalysts peel off from the current collector inhibiting long-term electrolysis and reducing current density. Furthermore, the electrode fabrication is an immensely arduous task mostly requiring many complex steps. It is therefore the main object of the invention to provide free-standing self-supported electrodes comprising SACs by a relatively simple and scalable process.

It is further an object of the invention to provide a simple and industrially scalable process for making single atom catalysts (SACs) efficient in both oxygen evolution reaction (OER) and cathodic hydrogen evolution reaction (HER).

It is still another object of the invention to provide free-standing self-supported electrodes comprising SACs without PGM that can catalyze both OER and HER.

It is also an object of the invention to provide high-performance, low-cost electrodes comprising SACs for water splitting and other electrochemical applications.

The invention aims at providing SACs comprising conductive substrates which exhibit good electronic conductivity and mechanical integrity during long-term cycling.

The invention also aims at providing SACs and electrodes comprising same for water electrolysis, based on nanocarbon matrix with single metal atoms selected from Earth abundant metals.

The invention further aims at providing an industrially scalable process for manufacturing a bi-functional SAC catalyzing both OER and HER efficient in water electrolysis, comprising a step of chemical vapor deposition.

It is a still further object of the invention to provide a robust electrochemical system for splitting water, comprising bi-functional SACs based on nanocarbon and Earth abundant metals.

Other objects and advantages of the present invention will appear as the description proceeds.

### SUMMARY OF THE INVENTION

The invention provides a process of manufacturing a single atom catalyst (SAC) and a free-standing self-supported electrode comprising said SAC, the SAC and the electrode being efficient in anodic oxygen evolution reaction (OER) and cathodic hydrogen evolution reaction (HER), comprising steps of i) providing a heat stable substrate; ii) depositing a weak-adhesion layer on said substrate; iii) depositing an Earth abundant metal (EAM) layer on said weak adhesion layer thereby obtaining a wafer for growing a layer of nanocarbon fibers; iv) heating said wafer of step iii) comprising the non-PGM layer and the EAM layer in a chemical vapor deposition (CVD) furnace in the presence of a carbon precursor, hydrogen and helium, thereby delaminating said weak-adhesion layer from said substrate and forming from said carbon precursor a delaminated layer of carbon nanofibers (CNF), the formation of said CNF layer comprising increasing the layer thickness and dispersing said non-PGM and said EAM within said CNF, thereby obtaining a compact mat of CNF with atoms and nanoparticles of said non-PGM and EAM; and v) doping said CNF mat with a dopant comprising an element selected from the group consisting of S, P, Se, B, and N, thereby obtaining a compact mat of doped CNF with atoms and nanoparticles of said non-PGM and EAM, the mat comprising SACs and being electronically conductive and mechanically stable to serve as a free-standing self-supported electrode. In preferred embodiments of the process according to the invention, said step iv) comprises a temperature of between 500 °C and 900 °C applied for a time interval of between 10 minutes and 360 minutes, and said step v) comprises a temperature of between 500 °C and 900 °C for a time interval of between 30 minutes and 120 minutes.

Said substrate is preferably selected from Si/SiO₂ wafer, glass, quartz, indium tin oxide, fluorine doped tin oxide, or high melting point metals. In a preferred embodiment of the invention, said weak adhesion layer is a film preferably between 10 nm and 200 nm thick, comprising a metal selected from Au, Ag, Pd, Ti, Ta, or a combination thereof. In some preferred embodiments of the invention, said EAM layer is a film preferably between 20 nm and 400 nm thick, comprising a metal selected from Ni, Co, Fe, Cu, Mo, or alloys thereof. Said depositing steps ii) and iii) are performed as a one-step electron beam evaporation or sputtering without breaking vacuum. In a preferred embodiment, the process of the invention employs electron beam evaporation. Said carbon precursor is preferably ethylene. In a preferred embodiment, the process according to the invention employs in said step iv) atmospheric pressure chemical vapor deposition (CVD). In some preferred embodiments, said dopant is vaporized sulfur. Said EAM is, in a preferred embodiment, nickel. Said weak adhesion layer preferably comprises gold. Said EAM is dispersed in the carbon phase on the level of nanoparticles with a size distribution comprising particles with very few atoms down to single atoms.

The process according to the invention preferably comprises a one-step CVD procedure providing an electronically conductive and mechanically stable compact SAC mat of sulfur-doped CNFs with atoms and nanoparticles of nickel and gold on them, said CVD preferably employing 800 °C for 2 hours; said one step comprising stages of delamination, growth of a nanocarbon mat, and formation of SACs which are eventually doped preferably with sulfur.

The invention provides a single atom catalyst being a bi-functional catalyst catalyzing both OER and HER. The bi-functional SAC catalyzing both OER and HER preferably comprises carbon nanofibers doped with sulfur, together with nickel and gold atoms and nanoparticles on the carbon nanofibers, comprising a high load of nickel.

In an important embodiment, the invention provides a free-standing electrode prepared according to any one of the processes described above. The invention relates to a free-standing self-supporting electrode essentially consisting of a compact SAC mat of sulfur-doped carbon nanofibers with nickel and gold atoms and nanoparticles, wherein the nickel load of said electrode is between 0.01 mg and 1 mg per 1 cm² of the electrode. Said electrode exhibits good electronic conductivity and mechanical integrity during long-term cycling.

The electrode of the invention exhibits high loading of single metal atoms on the carbon nanofibers. In a preferred embodiment of the invention, doping carbon nanofibers with sulfur lowers the overpotential of the electrode and enhances the electrochemical active surface area. The electrodes according to the invention are bi-functional electrodes based on Earth abundant metals, sufficiently robust for water electrolysis and other industrial electrochemical processes.

In one embodiment, the electrode according to the invention exhibits low OER overpotentials of 300 mV at the current density of 10 mA/cm². The electrode according to the invention exhibits in some embodiments low HER overpotentials of 40 mV at the current density of 17 mA/cm². In some embodiments, the electrode according to the invention exhibits endurance for OER and HER over 20,000 cycles with a negligible change in overpotential at higher currents. The electrodes of the invention usually exhibit high corrosion resistance of their carbon nanofibers.

In some preferred embodiments, the electrodes according to the invention may efficiently serve in water electrolysis, methanol oxidation reaction, glycerol oxidation reaction, and CO₂ reduction.

### BRIEF DESCRIPTION OF THE DRAWINGS

The above and other characteristics and advantages of the invention will be more readily apparent through the following examples, and with reference to the appended drawings, wherein:

FIG. 1. shows images of sulfur-doped electrodes synthesized at growth times from 30 sec to 120 minutes;

FIG. 2. presents HRSEM images of the delaminated electrodes at magnifications of 5000 and 20,000 times: sulfur-doped (above) and non-doped (below);

FIG. 3. shows X-ray diffractograms of samples grown from 10 to 120 minutes (the samples with the diamond mark are sulfur doped);

FIG. 4. shows LSV curves recorded for S-C-120 FS after 5 k and 20 k CV cycles;

FIG. 5. shows the iR-corrected linear sweep voltammetry results, carried out at 5 mV/s; and

FIG. 6. shows a comparison of an electrode according to the invention (the leftmost) with previously reported freestanding electrodes in regard with the HER and OER electrocatalytic performance in 1M KOH electrolyte, overpotential at current density of 10 mA/cm² is shown.

### DETAILED DESCRIPTION OF THE INVENTION

It has now been found that an efficient single atom catalyst (SAC) for use in water splitting systems can be obtained by synthesizing a mat of carbon nanofibers comprising nickel atoms after delaminating from a substrate due to a component between said substrate and said mat, the component exhibiting a weak adhesion to said substrate. Said substrate is preferably a SiO₂-based substrate, and said weak adhesion component is preferably a thin layer of gold. Said nickel atoms originate from a thin nickel layer deposited on said thin gold layer, both metal layers (stack) being deposited on said Si substrate by e-beam evaporation in one stage without breaking vacuum, thereby producing double coated Si based substrate samples. Said samples are employed as a base for growing said mat of carbon nanofibers by chemical vapor deposition (CVD), preferably under atmospheric pressure. The materials in contact with the Si substrate form a “delamination layer” or a layer with “weak adhesion” that detaches from the Si substrate during the thermal process, which includes exposure to a carbon-containing gas, preferably ethylene, at a high temperature; the mat of nanofibers is formed, going through the stages of nucleation and growth. Preferably, the nanocarbon mat is further doped with another element, preferably sulfur. Said high temperature usually comprises a temperature between 500 °C and 900 °C, such as between 700 °C and 900 °C, for example about 800 °C. Said gold and nickel layers have a thickness of tens to hundreds of nm each. Said nanocarbon mat has a thickness of up to several mm.

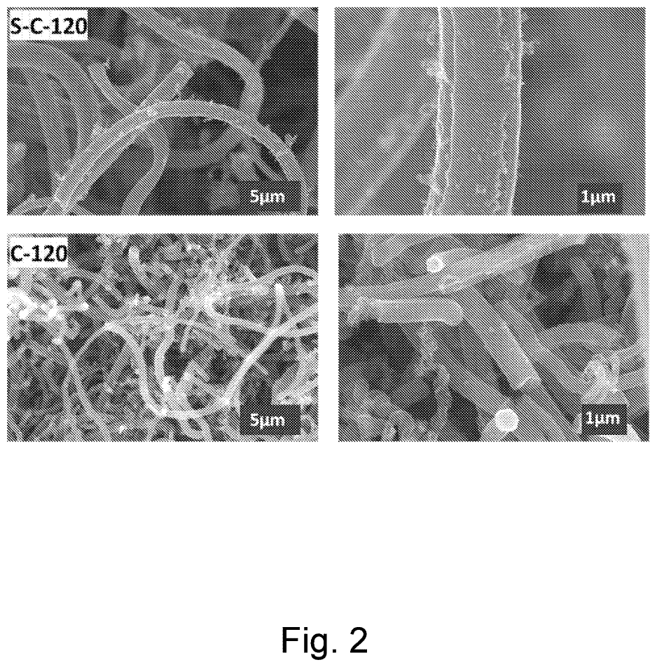

Developing high performance catalysts for electrochemical water splitting is critical to an efficient and sustainable route for hydrogen production. SACs seem promising, but the current methods for their preparation involve multiple, lengthy, and expensive steps, while often yielding an insufficient density of single atoms. The method of this invention provides superior SACs and also free-standing (FS) electrodes containing said SACs, wherein said SACs comprise Ni atoms on a matrix of sulfur-doped carbon nanofibers. Said FS electrode is obtained in a process comprising a temperature-controlled delamination of a thin film, with Au in contact with a SiO₂ substrate, leading to nucleating and growing said SACs. Advanced characterizations of the products obtained according to the invention indicate the presence of Ni and Au single atoms and of atom aggregates on a carbon nanofiber matrix, said atoms originating from the initial Au and Ni films from which they are dispersed throughout growing nanocarbon mat by a not entirely clear mechanism, providing a surprisingly active catalyst. Without wishing to be limited by any particular theory, the inventors believe that the mechanism comprises delaminating the stack of Ni/Au thin film from the Si substrate followed by fragmenting said stack into sub-micron particles that, in the presence of ethylene at high temperature, start the nucleation and the growth of the carbon nanofibers (see for example FIG. 2); doping the carbon nanofibers with sulfur vapor still further improves the catalyst efficiency, the mechanism possibly comprising lattice mismatch.

The obtained non-platinum group metal (non-PGM) electrodes showed exceptional performance for oxygen evolution reaction (OER) and hydrogen evolution reaction (HER). They, for example, performed for over 20,000 cycles with negligible change in overpotential at higher currents, with low onset overpotentials of 305 mV at 10 mA/cm² for OER and 40 mV at 17 mA/cm² for HER. The overpotential decreased to 195 mV at a current density of 100 mA/cm². Remarkably, the electrode performance improved over cycling, while gold was dissolving in the electrolyte. The synthesis according to the invention paves the way for the development of non-PGM high performance electrodes for water electrolysis and other electrocatalytic applications. The novel one-step, temperature-controlled delamination of thin SACs-films will provide new efficient electrodes in a process which is much simpler than known complex and expensive techniques (e.g., photolithography) and, importantly, a process which is industrially scalable.

For practical applications, the electrocatalysts should exhibit long-term stability and robustness, in addition to their electrocatalytic activity (e.g., overpotential, kinetics, active surface area, faradic efficiency, turnover frequency). Electrodes based on powders, for example, need binders (e.g., conducting polymers, mainly Nafion) for immobilizing the catalytic material on the current collector substrate; the problem of binders is that catalysts often peel off from the current collector, thus inhibiting long-term electrolysis and reducing current density. The FS electrodes of the invention avoid said problems and, furthermore, they lower the production cost of total water splitting due to the usability of the SACs of the invention for both OER and HER. The invention provides electrodes comprising SACs without binders, strong enough to perform long-term electrocatalysis in an industrial process. The invention provides, in one embodiment, synthesis of bi-functional, self-standing electrodes made of SACs on a sulfur-doped nanocarbon matrix, comprising a one-step chemical vapor deposition; said deposition includes (1) delamination of thin films from the substrate, (2) nucleation and growth of nanocarbon mat (the mat comprising carbon nanofibers), and (3) formation of SACs to be eventually doped with another element preferably sulfur.

The doping may be performed by a powder comprising, for example, S, P, Se or B, or mixtures or compounds thereof, such as co-doping powders, for example comprising S—N, S—P or S—B, or a gas such as N, or a bubbling dopant (e.g., solvent or solvent with nanoparticles) that is bubbled into the reactor using a temperature controlled bubbler. Said doping may be done by sublimating the dopant, for example sulfur, after the nucleation and growth step.

The process of manufacturing electrodes according to the invention comprises preparing a Si/SiO₂ substrate upon which thin films of a non-platinum group metal (non-PGM) and an Earth abundant metal (EAM) are deposited by e-beam evaporation or sputtering, all the metals forming a stack in one step without breaking vacuum. The stage of preparing said substrate is followed by a one-step-synthesis of a nanocarbon mat using CVD, including temperature annealing, delaminating the stack, nucleating and growing carbon nanofibers. In one important embodiment, the invention provides a one-pot process of manufacturing a bi-functional electrode for OER and HER, comprising the formation of a nanocarbon mat with Au and Ni atoms, delaminated at high temperature in a CVD furnace from a Si-based substrate coated with gold and nickel, and finally doped with sulfur vapor.

In some embodiments, the substrate for depositing non-PGM and EAM may be selected from glass, quartz, indium tin oxide (ITO), fluorine tin oxide (FTO), or high melting point metals. The weak adhesion layer may comprise Ag, Pd with a very thin layer of Ti or Ta and any combination thereof. The EAM to form the catalytic layer may comprise a metal selected from Co, Fe or Cu, or from metal alloys such as Ni—Co, Ni—Cu, Ni—Fe or Ni—Mo. In a preferred embodiment, said substrate is a Si/SiO₂ wafer, said PGM forming the weak adhesion layer is Au, and said EAM is nickel.

The process of manufacturing SACs on nanocarbon matrix comprises, in preferred embodiments of the invention, stages of i) providing a heat stable substrate, ii) depositing a weak-adhesion layer comprising non-PGM on said substrate, iii) depositing an Earth abundant metal (EAM) layer on said weak adhesion layer, iv) delaminating said weak-adhesion layer from said substrate and forming a layer of nanocarbon fibers from a carbon precursor, and growing said layer of nanocarbon fibers while dispersing said non-PGM and EAM within said nanocarbon fibers, and v) doping said layer of the nanocarbon fibers with a dopant comprising S, P, Se, N or B. The substrate of said stage i) may be selected from Si/SiO₂ wafer, glass, quartz, indium tin oxide (ITO), fluorine doped tin oxide (FTO), or high melting point metals. Said weak adhesion layer is a film preferably between 10 nm and 200 nm, such as between 15 nm and 150 nm thick, for example between 25 nm and 100 nm, comprising a metal selected from Au, Ag, Ti, Ta, or a combination thereof. Said EAM layer is a film preferably between 20 nm and 400 nm, such as between 30 nm and 300 nm thick, for example between 50 nm and 200 nm, comprising a metal selected from Ni, Co, Fe, Cu, Mo, or alloys thereof. Said depositing stages ii) and iii) preferably comprise electron beam evaporation and are performed in one step without breaking vacuum. Forming and growing the layer of nanocarbon fibers in said stage iv) preferably employs ethylene or other carbon precursor with hydrogen. The dispersion of said non-PGM and said EAM from its initial deposit onto the nanocarbon fibers in said stage iv) is achieved in a chemical vapor deposition furnace, and results in high loading of EAM nanoparticles exhibiting a size distribution comprising particles of very few atoms and single atoms. Said stage iv) comprises one-step formation of a SAC. Said dopant in stage v) is preferably sulfur. In a preferred embodiment, the SACs on nanocarbon matrix obtained in the process have a form of physically stable plate or wafer that can serve as a self-standing efficient electrode for industrial electrocatalysis. The process of the invention is in one embodiment a one-pot process for manufacturing bi-functional electrodes for both OER and HER.

The deposition of the weak adhesion layer and of the EAM layer may be performed by e-beam evaporation, by sputtering, or by other techniques. The thickness of the weak adhesion layer and/or the EAM layer may be adjusted. Typically, the thickness is in the range of from about tens to hundreds of nanometers. The substrate with the deposited layers is heated in a CVD furnace preferably in the presence of He, H₂, and C₂H₄ to nucleate and grow the nanocarbon matrix upon which the SACs form. In some embodiments of the invention, the temperature in the CVD furnace is about 800 °C, and the time of nanocarbon growth before the doping is between 10 minutes and 360 minutes, for example from 60 minutes to 120 minutes. After the nanocarbon growth, the dopant, preferably sulfur, is vaporized in the upstream furnace and carried with a flow of He to the downstream furnace to dope the nanocarbon matrix. As a final product, a delaminated black mat with a slightly larger area than the substrate wafer is obtained, the thickness of the mat is usually from 0.2 mm to 6 mm, such as between 0.5 mm and 5 mm, for example between 1 mm and 4 mm.

The process for preparing SACs on nanocarbon matrix of the present invention is an economical and scalable process. It involves synthesizing SACs on a doped nanocarbon matrix directly usable as a bi-functional catalytic electrode, synthesized by CVD in one step without post processing or coating while avoiding binders. Preferably, the free-standing and self-supported (FS) electrodes of the invention comprise sulfur-doped carbon nanofiber mats with Ni/Au SACs. The process of manufacturing the electrodes, obviating the use of binders and glues, is technologically simple, and the electrodes exhibit superior mechanical and electrical properties, and importantly they exhibit excellent performance even during long-term and repeated use. The SACs and the FS electrodes of the invention exhibit a high metal load and a high density of active sites. In some embodiments, nickel load may achieve more than 1 mg per gram of the electrode, such as more than 2 mg per gram, or more than 3 mg per gram of the electrode. Assuming complete conversion of the EAM thin film into SACs, the nickel load may be in some embodiments more than 1 mg per 1 cm² of the electrode; in other embodiments, the load may be up to 1 mg per 1 cm² of the electrode. The electroactive species with the conductive substrates of the SACs according to the invention exhibit good electronic conductivity and mechanical integrity for long-term cycling. The electrodes of the invention outperform electrodes based on platinum metals, such as state-of-art electrodes based on RuO₂.

The electrodes of the invention may be advantageously employed for electrocatalysis and for energy applications, preferably for cathodic hydrogen evolution reaction (HER) and anodic oxygen evolution reaction (OER). Other possible applications include methanol oxidation reaction, glycerol oxidation reaction, CO₂ reduction, and other electrocatalytic reactions. The electrocatalytic performance of the doped electrodes is superior to the same non-doped electrodes, possibly due to the increased electrical conductivity.

The invention will be further described and illustrated by the following examples.

### EXAMPLES

### Example 1

### Synthesis of Au/Ni SACs on Nanocarbon Mat (C-10, C-30, C-60 and C-120)

Using electron beam (e-beam) evaporation without breaking vacuum we deposited Au (50 nm) and Ni (100 nm) on a Si/SiO₂ wafer from which we cut rectangular samples of 2.5 cm×1 cm. Rutherford back scattering (RBS) measurements were done to verify the correct thickness and materials. We processed these samples using two atmospheric pressure chemical vapor deposition (CVD) furnaces (Lindberg Blue TF55035C-1) in series equipped with a fused silica (quartz) tube (internal diameter of 22 mm) with gas flow regulated by electronic mass flow controllers (MKS model P4B) with a digital mass flow control unit (MKS model 247D).

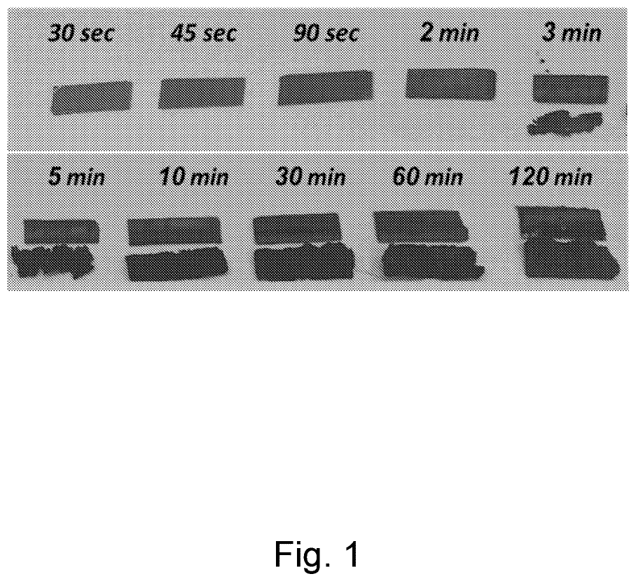

We placed the sample in an alumina boat at the exit of the downstream furnace outside the heated zone. First, we purged the reactor with He gas (99.9999%, Gas Technologies) 100 standard cubic centimeter per minute (sccm) at room temperature for 15 min with the boat outside the heated zone until the furnace reached the desired temperature. We then introduced 100 sccm He, 200 sccm H₂ and 200 sccm C₂H₄ to delaminate the thin film stack and nucleate and grow the nanocarbon mat. Using the “fast-heat” technique described previously (G. D. Nessim, M. Seita, K. P. O'Brien, A. J. Hart, R. K. Bonaparte, R. R. Mitchell and C. V Thompson, Nano letters, 2009, 9, 3398-3405) the sample remained at room temperature positioned outside the exit of the second furnace while the furnace was heated to the desired temperature. We thus heated the sample to the desired temperature without exposing it to the temperature ramp. When the furnace reached 800 °C the boat with the sample was introduced into the heated zone by pushing the quartz tube back and heated for the required duration (30 s to 2 h). At the end of the synthesis the tube was pushed out to position the boat containing the wafer outside the heating zone to cool under a flow of He. The delaminated dark mats (carbon mats separated from the Si/SiO₂ wafer), having the form of strips, approximately of the same shape as the Si/SiO₂ wafer, obtained after reacting for 10 min to 2 h are termed C10 (10 min), C-30 (30 min), C-60 (1 h) and C-120 (2 h) (photographs of the mats and their Si-wafers are shown in FIG. 1).

### Example 2

### Synthesis of Au/Ni SACs on Sulfur Doped Nanocarbon Mat (S-C-10, 30, 60 and 120)

The wafer with the thin films used here is the same as described in Example 1 above, and the thermal process using the same CVD system is very similar with the only addition that we now had a second boat with sulfur powder that was heated at 400 °C to sublimation in the upstream furnace while the sample with the thin films is heated in the downstream furnace. We placed a ceramic boat with 1 g of sulfur powder (Alfa Aesar, 99.5%, 325 mesh) outside the first furnace upstream of the gas flow and a second boat with a 2.5 cm×1 cm piece of SiO₂/Au (25-100 nm)/Ni (50-200 nm) outside the second furnace downstream of the flow. We purged the system using He 100 sccm (99.9999%) for 15 min while keeping the two boats at room temperature (outside the heated zones) until the furnace reached equilibrium at the desired temperatures in the two zones to remove all air and fill the reactor with helium. To grow the nanocarbon with the SACs we shifted the quartz tube to put the second boat inside the downstream furnace for 30 s to 2 h while flowing 100 sccm He, 200 sccm H₂ and 200 sccm C₂H₄ gases. After that, using an external magnet we introduced the boat with the sulfur powder in the upstream furnace for 60 min under a flow of 100 sccm He to transport the sublimated sulfur gas to the downstream furnace to react with the sample at 800 °C. At the end of the synthesis the boat with the sulfur was pulled out of the heated zone using the magnet and the quartz tube was pushed out to position again the boat containing the wafer outside the heating zone to cool under a flow of helium. The sulfur doped delaminated mats obtained after reacting for 10, 30, 60 and 120 min are termed S-C-10, S-C-30, S-C-60 and S-C-120.

### Example 3

### Characterization of the Au/Ni SACs

### High-Resolution Scanning Electron Microscopy

High-resolution scanning electron microscopy (HRSEM) of the delaminated samples shows entangled carbon nanofibers (CNFs) with micron-range diameters (FIG. 2). Focused ion beam (FIB) on a cross-section of the doped sample, and EDX measurements that indicate the presence of carbon, sulfur, nickel and gold, were performed. The FIB cross-section shows that the nickel content decreases as we get deeper into the sample, which correlates with the results obtained from X-ray photoelectron spectroscopy (XPS) where Ni was detected only when we positioned the sample upside down.

### Raman Spectroscopy

Raman spectroscopy measurements of S-C-120 (2 h sulfur doped sample) show a G band peak at ^{~}1580 cm⁻¹ and a 2D band peak at ^{~}2700 cm⁻¹. The ratio D/G=1.08 indicates a graphitic structure where the D band indicates a defect in the graphitic structure which arises from out-of-plane vibration, while the G band originates from in-plane vibration of the C—C bond from the sp² orbital hybridization.

### High-Resolution Transmission Electron Microscopy

The 2 h sample doped with sulfur and without doping were characterized using aberration-corrected high-resolution transmission electron microscopy (HRTEM) with high-angle annular dark-field imaging (AC HAADF-STEM) with a resolution of at least 0.1 nm. This enabled to properly observe dots made by single atoms or by particles of very few atoms characterizing single atom catalysts (SACs). We performed extensive electron dispersive spectroscopy (EDS) and subsequent mappings of the different elements on the S-C-120 sample. This mapping showed that the dots are made of Ni, Au, or possibly both and that carbon and sulfur are uniformly distributed. The observations suggest dimensions <1 nm. We also performed HAADF on the S-C-120 sample and likewise found Au particles around 200 nm in size

### Morphology and Structure (XRD, XPS, Contact Angle)

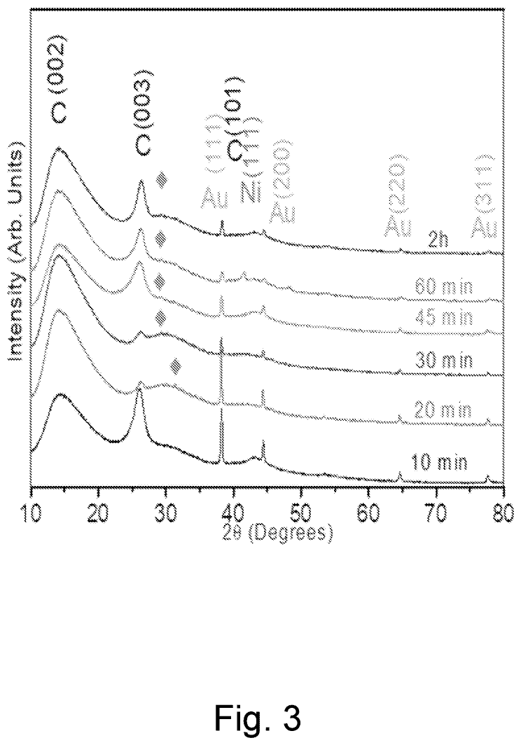

To understand how growth time affects morphology and structure we varied the growth duration from 30 s to 2 h, followed by 1 h of sulfur doping. The fine-tuning as a function of growth duration is evident from the X-ray diffractograms in FIG. 3. Peaks of carbon were found at (002), (003) and (101) from 2θ values of 14.3°, 26.2° and 41.5°. The Ni (111) peak is around 44.2°. Gold peaks are at (111), (200), (220) and (311) from 2θ values of 38.4°, 44.8°, 64.9° and 77.7°. The presence of Ni and Au is evident not only from the expected peak positions but also from the widening of the Ni (111) peak. This widening is very characteristic of the formation of Ni nanoparticles, albeit to the extent that these nanoparticles are present mostly as single atoms throughout the carbon support. We characterized a cross-section (lamella) of the sample using FIB to see how Ni penetrates the carbon material. Over a depth of around 10 micron we observed that the concentration of the nickel is at its lowest on the surface of the nanocarbon mat and increases with depth. This observation is consistent with XPS measurements where we only detected Ni at the bottom of the nanocarbon (i.e., the part of the electrode in contact with the substrate before delamination) indicating that the amount of Ni on the surface of the nanocarbon increases with depth.

Structural parameters (average interlayer spacing between carbon layers, d(002), and average size of basic structural units in direction perpendicular to layers, Lc) obtained from analysis of XRD patterns were determined by means of quantitative analysis of the (002) carbon peak and are given in the table below. The values of the interlayer spacing for d₀₀₂, calculated from the Bragg's law as d₀₀₂=nλ/2 sin θ, and crystallite height (stack height) (Lc) estimated via the Scherrer's equations L_{c}=0.94λ/B cos θ where, B is the FWHM (full-width at half-maximum) and θ is the Bragg angle of (002) band for Lc (see P. Wang and B. Wang, ChemSusChem, 2020, 13, 4795-4811).

| Sample | d(002) [nm] | Lc [nm] |
|---|---|---|
| C-120 | 0.348 | 2.7 |
| S-C-120 | 0.344 | 3.5 |

The sulfurization step is evident in the improvement of graphitic order by d₀₀₂ decrease followed by Lc increases for both S-C-120 and post S-C-120. Lower values of d₀₀₂ indicate less defects on graphitic layers leading to a better packing of the carbon nanofibers.

To understand the roles of Ni and Au, XRD of samples grown for increasing durations from to 120 min were performed, with specific focus on the differences in peak intensity of Ni and Au (FIG. 3). The intensity of the Au peak at 38.4° diminishes for increased growth duration but without peak broadening indicating that the particle dimensions of Au are most likely greater than the Ni SACs (SACs are usually reported to be about an angstrom in size). The weaker intensity of the Au peaks at 44.8°, 64.9° and 77.7° indicates only the planes of their growth. Initially, the most preferred growth orientation at 10 min reaction seems to be in the (111) plane but the intensities become almost comparable to the other three crystallographic planes ((220), (200) and (311)) confirming that Au particles are larger than Ni particles. The Ni peaks are consistently broad for all growth durations with almost no shift in the (111) peak position at ^{~}44.2°. The broad and highly intense nature of the (002) and (003) C peaks at 14.3° and 26.2° are characteristic of the formation of the carbon matrix. The doping with S is indicated with yellow diamond shapes in the XRD pattern.

Using XPS, we probed the chemical states and bonding environments of elements present in the grown doped samples. The C 1s spectrum revealed the presence of sp² hybridized carbon (peak position at 284.7 eV) and C—S bonding and π-π* transition as the deconvoluted peaks at 285.4 and 290.5 eV respectively. The high-resolution spectrum of S 2p can be divided into S 2p_{3/2} and S 2p_{1/2} at 164.2 and 165.5 eV respectively, attributed to the C—S linkage. An additional peak was observed at 168.5 eV due to SOx bonding. The core-level spectrum of Ni 2p_{3/2} was deconvoluted to three peaks positioned at 856.2, 861.5 and 862.8 eV which can be assigned to high valence Ni (Ni⁺³) and satellite peaks.

The XP spectrum also showed two well-defined Au 4f peaks where peaks at 84.1 and 88.1 eV, corresponding to Au 4f_{7/2} and Au 4f_{5/2} respectively, suggesting the existence of metallic Au.

We also performed contact angle measurements. The contact angle of the non-doped sample was 128.7° compared to 143.2° for the sample doped with sulfur, indicating that the doped sample is more hydrophobic (almost super-hydrophobic), which may be important for explaining the electrocatalytic performance.

### Example 4

### Experimental Setup for Electrochemical Water Splitting

The electrochemical examinations were carried out using a Biologic (VSP-128) potentiostat. Electrocatalytic OER studies were done in a three-electrode cell. The delaminated strips of Examples 1 and 2 were used as electrodes in some measurements. For the powder samples, a catalyst ink was prepared by grinding the delaminated samples in a mortar and mixing 4 mg of the obtained catalyst powder with 600 μL of deionized (DI) water, 350 μL of ethanol, and Nafion to 5%, followed by sonicating for about 45 min. We drop casted 8 μL of the ink over a 5 mm glassy carbon electrode (GCE) and dried at ambient conditions. The catalysts loaded over GCE served as the working electrode with Hg/HgO (filled with 1M NaOH) and a Pt spiral as reference and counter electrodes, respectively. We utilized RRDE 3A (ALS, Japan) for the rotation of electrodes in rotating disk electrode (RDE) mode. Initially I-V polarization was carried out by measuring the cyclic voltammogram (CV) during 100 cycles with a sweep rate of 50 mV/s.

In a similar way, we took 10 mg of both RuO₂ and Pt/C and added to the mixture of 500 μL of DI water, 400 μL of absolute ethanol 100 μL of 5% Nafion solution and sonicated for 30 minutes. 100 μL of each catalyst ink drop casted on previously cleaned carbon papers (1 cm²). Finally, the electrodes were dried and used for electrochemical studies. S-C-120 FS and C-120 FS delivered a current density of 50 mA/cm² at corresponding η of 380 and 420 mV. Further, S-C-120 FS and C-120 FS outperform the OER activity of state-of-art RuO₂. RuO₂ displays the current density of 10 mA/cm² at an overpotential of 340 mV.

For electrochemical impedance spectroscopy (EIS) we fixed the frequency in the range of 100 kHz to 100 mHz (small perturbation of 10 mV). The potential scale as per the reversible hydrogen electrode (RHE) was calibrated to E_{RHE}=E_{Hg/HgO}+0.93 V and thus we calculated the overpotential as η=E_{RHE}−1.23 V. We carried out the OER and HER studies in 1M KOH (pH 14) under ambient conditions with saturation of the electrolyte using argon gas. While testing our samples we observed that only those synthesized for 1 or 2 h exhibited sufficient mechanical strength to be used as FS electrodes. Catalysts in powder form are usually drop cast over a current collector where Nafion, quaternary ammonium-based ionomers, FuMA-tech FAA-3 and Tokuyama AS-4 are used as binders for practical application. Despite the wide use of ionomer binders in the water electrolyzer and fuel cell industries, the use of binders is not satisfying. For example, particles of catalysts bonded with each other attached to the current collector with a binder exhibit greater electron transfer resistance attributed to poor adhesiveness between the catalyst layer and the collector which eventually reduces the catalytic activity.

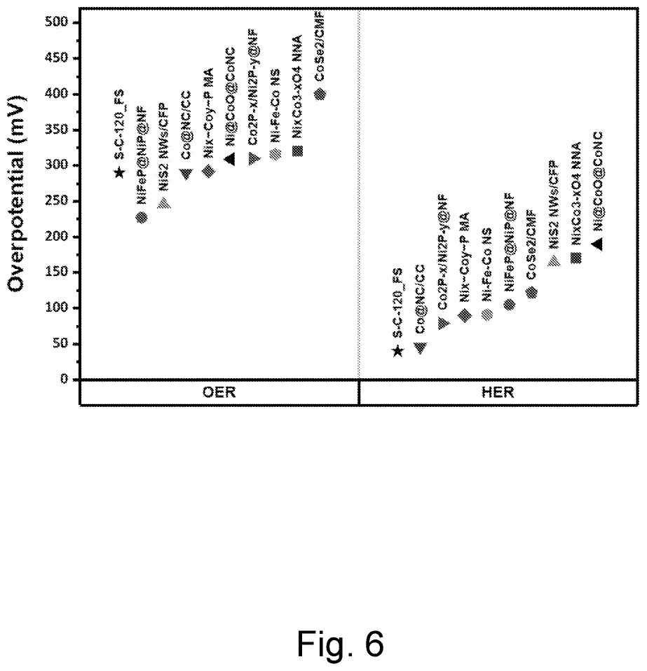

The method of the present invention succeeds in synthesizing free-standing electrodes with sufficient mechanical strength to perform electrocatalysis without binders. These binder-free self-standing electrodes do not exhibit the problems mentioned above for powder-based/binder electrodes. We analyzed the OER and HER performance of the FS electrodes by electrochemical testing in a typical three-electrode setup with a PTFE replaceable holder as current collector for the working platinum electrode. The one-step synthesis of the catalytic strips (CNF mats), without post processing or coating while avoiding organic binders, provided the electroactive species exhibiting good electronic conductivity and mechanical integrity under the conditions of long-term catalysis. As for OER performance, the S-C-120 FS electrode according to the present invention is comparable with published catalysts, and in many aspects, it even outperforms most of the previous catalysts (see for example FIG. 6).

### Example 5

### Oxygen Evolution Reaction (OER)

We first tested the powder from grinding the non-doped samples for the various growth durations (10, 30, 60, 120 min). Their comparative linear sweep voltammetry (LSV) shows that C-10, C-30 and C-120 exhibit almost the same onset overpotential of 330 mV, while C-60 exhibits 370 mV. C-10 and C-120 delivered a current density of 10 mA/cm² at overpotential of 430 and 470 mV respectively, while C-30 and C-60 failed to deliver a higher current.

We then performed LSV of the sulfur-doped grinded samples and observed a different trend. The S-C-10, S-C-30, S-C-60 and S-C-120 powders reached the same current density of 10 mA/cm² at a respective overpotential of 420, 470, 480 and 400 mV, clearly indicating a significant effect of sulfur on OER activity. Among these samples S-C-120 outperformed the other synthesized materials in terms of lower overpotential with the activity trend being: S-C-120>S-C-10>S-C-30>S-C-60. For all powder samples we analyzed the kinetics of synthesized delaminated electrodes using the Tafel equation [η=a+b×log j] with a=constant, b=2.3 RT/αF, and j=current density. To avoid the effect of mass transfer we carried out the LSV under rotation of the electrode (RDE) at 1600 rpm. The ohmic drop corrected Tafel slopes were 51, 55, 61 and 58 mV/dec for the non-doped C-10, C-30, C-60 and C-120 respectively. C-10 showed faster kinetics while oxidizing water. The sulfur-doped S-C-10, S-C-30, S-C-60 and S-C-120 exhibited slopes of 57, 54, 75 and 50 mV/dec with the smaller Tafel slope of S-C-120 validating the improved OER kinetics.

We also tested the FS electrodes synthesized for 2 hours (C-120 FS and S-C-120 FS) that showed sufficient mechanical resistance to withstand electrocatalysis. The activity of FS electrodes was evaluated in an alkaline electrolyte (1M KOH). We performed cyclic voltammetry (CV) to understand the redox nature of the synthesized C-120 FS and S-C-120 FS. CVs of C-120 FS and S-C-120 FS were measured after I-V polarization (100 CV cycles carried out in both cases). Initially, C-120 FS exhibited the characteristic oxidation peak at 1.39 V vs. RHE and a reduction peak at 1.29 V vs. RHE, which could be due to the redox couple of Ni, while after 2000 CV cycles it showed an oxidation peak at 1.41 vs. RHE and with the same value for the reduction peak. S-C-120 FS showed a Ni redox peak at 1.4 V vs. RHE for oxidation and a reduction peak at 1.25 V. Similarly, after 2000 CV cycles the reduction peak was at the same potential as the initial cycle while the oxidation peak of Ni shifted to 1.42 V.

As mentioned above the performance of the sulfur-doped FS electrodes was quite better compared to the pristine electrode in accordance with the improved electronic conductivity due to S-doping. Furthermore, we noticed the dissolution of gold into the electrolyte solution, consistent with the report that Au dissolution starts at 1.2 V vs. RHE in an alkaline solution. After 500 cycles we noticed a gradual color change of the electrolyte from shiny yellow to dark red as Au atoms or nanoparticles detach from the carbon with possible formation of defects that further activate the surface to better catalyze the OER.

The LSV that was carried out at 5 mV/s suggests that S-C-120 FS delivers the benchmarking current density of 10 mA/cm² at an overpotential (n) of 350 mV and shows much higher OER activity than C-120 FS which exhibited η@10 mA/cm²=300 mV. S-C120 FS and C-120 FS deliver a current density of 50 mA/cm² at corresponding η of 380 and 420 mV. The reaction kinetics exhibited by electrodes can be studied using their corresponding Tafel plots extracted from the LSV curves. S-C-120 FS exhibited a smaller Tafel slope of 65 mV/dec while C-120 FS exhibits a slightly higher slope of 68 mV/dec. The higher slopes of the FS samples as compared to the same samples from powders could be due to the formation of large gas bubbles attached to the electrode surface.

The electrochemical active surface area (ECSA) is a useful descriptor for an electrocatalyst. The ECSA can be calculated as ECSA=C_{dl}/Cₛ where Cₛ is the specific capacitance (Cs value can be 0.04 mF/cm² in 1 M KOH as per reports) and Cdl denotes the double-layer capacitance, which is assessed from CV measurements at different sweep rates carried out in the non-Faradaic regions (no interfacial charge transfer). C-120 FS exhibited Cal of 98 mF/cm² whereas S-C-120 FS exhibits much higher Cal of 257 mF/cm², and their corresponding ECSA were 2450 and 6425 cm². S-doping thus not only lowers the overpotential but also significantly enhances the ECSA.

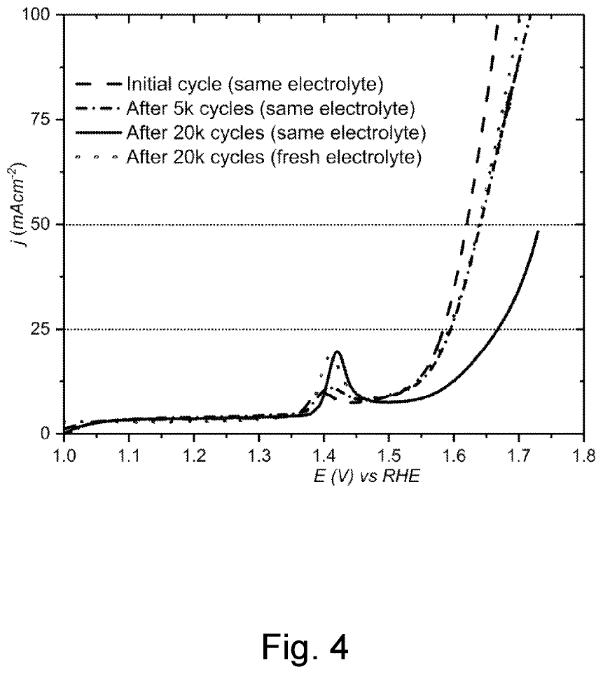

The stability of S-C-120 FS was measured using chronoamperometry, which is a potentiostatic method. We applied a potential of 1.54 V vs. RHE (j=13 mA/cm²) to observe the change in current density over time. The system took 4 h to deliver the constant j, showing excellent stability up to 24 hours as it retained 93% of current density. An interruption was seen, which could result from the accumulation of formed O₂ gas bubbles at the surface of the electrode. It is known that the design of super hydrophobic surfaces could assist in bubble detachment, thus rendering the electrode more robust. The contact angle measurements reveal that S-C-120 FS is more hydrophobic than C-120 FS (see Example 3), which could be the reason for its greater robustness. The durability of the electrode is shown by prolonged CV of 5,000 cycles that exhibited negligible loss of potential (FIG. 4). We studied the OER durability of the electrode for about 20,000 cycles and observed a huge change in potential in the same electrolyte; however, when we switched to a fresh electrolyte, we observed a very pronounced activity with negligible loss in potential (η@25 mA/cm²=10 mV), better than what observed after 5,000 cycles.

Electrochemical impedance spectroscopy (EIS) is useful for understanding the charge transfer mechanism during electro-oxidation of water to O₂. At the initial cycles S-C-120 FS exhibited high resistance as well as high charge transfer resistance, as the diameter of the semicircle is quite larger owing to poor conductivity. However, after 2000 cycles S-C-120 FS becomes more active towards faradic reactions as shown in EIS by the smaller arc of semicircles indicating better charge transfer resistance and improved electronic conductivity. The two types of semicircles observed for S-C-120 FS can be attributed to the presence of two time-constants.

It is noted that gold was found in the solution during OER cycling (starting after 250 cycles and observed until 20,000 cycles), which may indicate that the Au atoms on top of the carbon leach out to the electrolyte solution. Interestingly, the performance of the electrode increased during leaching of the gold: we could speculate that some of the gold de-alloyed from possible Ni—Au alloy dots making them Ni only, thereby enhancing the electrocatalytic performance. We also found larger gold chunks on the nanocarbon matrix which may detach and dissolve during electrocatalysis.

### Example 6

### Hydrogen Evolution Reaction (HER)

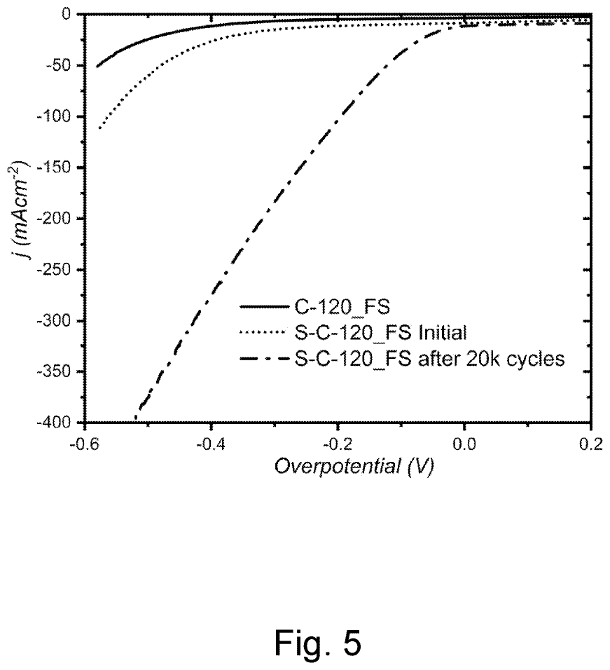

The HER catalytic performance of the FS electrodes was assessed in 1M KOH electrolyte saturated by purging 99.9% of Ar gas for about 30 min. Initially, just after I-V polarization (after 100 CV cycles @ 50 mVs⁻¹), C-120 FS and S-C-120 FS showed large HER onset overpotential of 400 and 340 mV at the current densities of 11 and 18 mAcm⁻² respectively. The performance improvement by S-C-120 FS as compared to C-120 FS proves its suitability for further HER studies. While subjecting the electrode for 20,000 cycles to check its robustness under alkaline condition, astonishingly we observed the dramatic enhancement of the performance as shown in FIG. 5. After 20 k cycles, S-C-120 FS shows low onset overpotential of 40 mV @ 17 mAcm⁻² and reaches the j of 50 mAcm⁻² and 100 mAcm⁻² at the low overpotential of 123 and 195 mV respectively. The Tafel slopes of 305, 283 and 285 mVdec⁻¹ were observed for C-120 FS, SC-120 FS and S-C-120 FS after 20 k cycles. We carried out the electrolysis in static conditions and observed large and non-linear Tafel slopes due to the accumulation of gas bubbles and the existence of mass transfer effects, thus failing to display the actual kinetics of the catalysts. We did the EIS analysis at the faradic potentials (at the operating conditions of 100 kHz-100 mHz frequency range; 5 mV amplitude). EIS spectra revealed that after 20 k cycles, S-C-120 FS showed a much smaller semicircle than the initial cycles of S-C-120 FS and C-120 FS, indicating better conductivity after 20 k cycles. We observed two atypical incomplete semicircles in these three cases: one small semicircle at the higher frequency representing bulk electrolyte resistance and a large semicircle formed at lower frequency representing the charge transfer resistance owing to H₂ evolution. We did chronoamperometry to study the stability of electrode after 20 k cycles. The electrode showed good HER stability after 10 h and the disturbance in meantime could be attributed to the accumulation of gaseous bubbles. Overall, the results imply that diffusion of electrolyte into the electrodes (for wetting) takes longer time to activate the electrodes (^{~}2500 CV cycles @ 20 mVs⁻¹), to allow the reactant species (H₂O) to reach the catalytic active sites.

While the invention has been described using some specific examples, many modifications and variations are possible. It is therefore understood that the invention is not intended to be limited in any way, other than by the scope of the appended claims.

1. A process of manufacturing a single atom catalyst (SAC) and a free-standing self-supported electrode comprising said SAC, the SAC and the electrode being efficient in catalyzing anodic oxygen evolution reaction (OER) and cathodic hydrogen evolution reaction (HER) comprising steps of
i) providing a heat stable substrate;
ii) depositing a weak-adhesion layer comprising a non-platinum group metal (non-PGM) on said substrate;
iii) depositing an Earth abundant metal (EAM) layer on said weak adhesion layer, thereby obtaining a wafer for growing a layer of nanocarbon fibers;
iv) heating said wafer of step iii) comprising the non-PGM layer and the EAM layer in a chemical vapor deposition (CVD) furnace in the presence of helium, hydrogen and a carbon precursor, thereby delaminating said weak-adhesion layer from said substrate and forming a delaminated layer of carbon nanofibers (CNF) from said carbon precursor, the formation of said CNF layer comprising growing the layer thickness and dispersing said non-PGM and said EAM within said CNF, thereby obtaining a compact mat of CNF with nanoparticles and atoms of said nonPGM and EAM; and
v) doping said mat of CNF with a dopant comprising an element selected from the group consisting of S, P, Se, B, and N, thereby obtaining a compact mat of doped CNF with atoms and nanoparticles of said non-PGM and EAM, the mat comprising SACs, and being electronically conductive and mechanically stable to serve as a free-standing self-supported electrode.

2. The process according to claim 1, wherein said step iv) comprises heating at a temperature of from 500 °C to 900 °C for a time interval of between 10 minutes and 360 minutes, and wherein said step v) comprises heating at a temperature of from 500 °C to 900 °C for a time interval of between 30 minutes and 120 minutes.

3. The process according to claim 1, wherein said substrate is selected from Si/SiO₂ wafer, glass, quartz, indium tin oxide, fluorine doped tin oxide, or high melting point metals.

4. The process according to claim 1, wherein said weak adhesion layer is a film preferably between 10 nm and 200 nm thick, comprising a metal selected from Au, Ag, Pd, Ti, Ta, or a combination thereof.

5. The process according to claim 1, wherein said EAM layer is a film preferably between 20 nm and 400 nm thick, comprising a metal selected from Ni, Co, Fe, Cu, Mo, or alloys thereof.

6. The process according to claim 1, wherein said depositing steps ii) and iii) are performed as a one-step electron beam evaporation or sputtering without breaking vacuum.

7. The process according to claim 1, wherein said carbon precursor is ethylene.

8. The process according to claim 1, wherein said step iv) in claim 1 comprises atmospheric pressure chemical vapor deposition (CVD).

9. The process according to claim 1, wherein said dopant is vaporized sulfur.

10. The process according to claim 1, wherein said EAM is nickel.

11. The process according to claim 1, wherein said weak adhesion layer comprises gold.

12. The process according to claim 1, comprising a one-step CVD procedure providing an electronically conductive and mechanically stable compact SAC mat of sulfur-doped CNF with atoms and nanoparticles of nickel and gold, said CVD employing 800 °C for 2 hours.

13. A single atom catalyst (SAC) being a bi-functional catalyst catalyzing both OER and HER prepared according to the process of claim 1.

14. A bi-functional SAC catalyzing both OER and HER, comprising carbon nanofibers doped with sulfur, and further nickel and gold atoms and nanoparticles on said nanofibers.

15. A free-standing electrode prepared according to the process of claim 1.

16. A free-standing self-supporting electrode consisting essentially of a compact SAC mat of sulfur-doped carbon nanofibers with nickel and gold atoms and nanoparticles, wherein the nickel load of said electrode is between 0.01 mg and 1 mg per 1 cm² of the electrode.

17. An electrode according to claim 16, exhibiting good electronic conductivity and mechanical integrity during long-term cycling.

18. (canceled)

19. An electrode according to claim 16, wherein doping said carbon nanofibers with sulfur lowers the overpotential of the electrode and enhances the electrochemical active surface area.

20. (canceled)

21. An electrode according to claim 16, exhibiting lowered OER and HER overpotential of 300 mV and 40 mV, respectively, at the current density of 10 mA/cm² and 17 mA/cm², respectively.

22-23. (canceled)

24. An electrode according to claim 16, efficient in water electrolysis, methanol oxidation reaction, glycerol oxidation reaction, and CO₂ reduction.
